(19) United States
(12) Patent Application Publication
(10) Pub. No.: US 2013/0299326 A1
(43) Pub. Date: Nov. 14, 2013

(54) WIRELESS KEYBOARD WITH A SPECIALLY DESIGNED POWER SWITCH STRUCTURE

(71) Applicant: Pei-Yu HSU, Zhongli City (TW)

(72) Inventor: Pei-Yu HSU, Zhongli City (TW)

(73) Assignee: SIN MEI ELECTRONICS CO., LTD., Guishan Township (TW)

(21) Appl. No.: 13/471,088

(22) Filed: May 14, 2012

(51) Int. Cl. H01H 13/76

(52) U.S. Cl. 200/5 A

(57) ABSTRACT

A wireless keyboard includes a keyboard body carrying a set of operating key switches, an elongated spacer block hinged to the front side of the keyboard body and turnable between a first position where the elongated spacer block is kept at the front side of the keyboard body in a substantially flush manner and a second position where the elongated spacer block is attached to a bottom side of the keyboard body for supporting the keyboard body on a flat surface in a tilted condition, a circuit module consisting of a circuit board, a battery power supply, a wireless module and a solenoid switch, and a magnetic member for acting with the solenoid switch to switch off the battery power supply when the elongated spacer block is in the first position or to switch on the battery power supply when the elongated spacer block is in the second position.

### BACKGROUND OF THE INVENTION

1. Field of the Invention

The present invention relates to power control technology and more particularly, to a wireless keyboard with a specially designed power switch structure, which automatically switches off the battery power supply when lifted from the work place after the use, avoiding the problem of power loss due to forgetting to turn off the power supply.

2. Description of the Related Art

Following continuous development of electronic technology, many different advanced electronic products, such as advanced computer system, cell phones and TV have been continuously created to serve people. Nowadays, notebook and tablet computer have been intensively used by people to substitute for desk computer. The population of advanced computer system causes people to change their habit of using computer. Further, some advanced electronics, such as smart phone, PDA, palm-top computer has word processing, photographing, music playing, network connecting, memorandum, e-mail and many other functions combined therein.

The popularly used tablet PC, smart phone and network TV commonly provide a touch screen and/or small buttons for operation. These data input devices are not convenient for the input of large data. Some advanced electronic devices provides a wireless input function. These advanced electronic devices commonly have a wireless module built therein for allowing data input through a wireless keyboard. For the advantage of being highly movable to any place or angle within a predetermined effective sensing range, wireless keyboard has been greatly accepted by consumers. Because a wireless keyboard does not equip any cable on the outside, it must have a battery power supply installed therein to provide the necessary working voltage for functioning.

Following the market trend to create electronic products having light, thin, small and short characteristics, a mobile electronic product user may carry a wireless keyboard to a school, client place, office, restaurant or any other place for use with their mobile electronic product for writing a report, speech, literature, etc. A regular wireless keyboard generally provides a power switch for switching on/off the battery power supply. In actual application, due to tight schedule or some other reasons, a wireless keyboard user may forget to switch off the battery power supply after working.

Further, to achieve the feature of low-profile, the size of the battery power supply of a wireless keyboard is limited, inconsequence, the capacity of the battery power supply is relatively restricted. If a wireless keyboard user forgets to turn off the battery power supply of the wireless keyboard, the battery power supply will be constantly kept under power-on status. In this case, the internal wireless module, circuit components and light-emitting devices keep consuming the battery power, and the power of the battery power supply will soon be exhausted. Further, when one is using a wireless keyboard to make a presentation or class data file and the power of the battery power supply of the wireless keyboard becomes exhausted, the wireless keyboard will become not functionable, and the user will be unable to keep working.

Therefore, there is a strong demand for a wireless keyboard, which avoids the problem of forgetting to turn off the battery power supply after working.

### SUMMARY OF THE INVENTION

The present invention has been accomplished under the circumstances in view. It is one object of the present invention to provide a wireless keyboard with a specially designed power switch structure, which automatically switches off the battery power supply when lifted from the work place after the use, avoiding the problem of power loss due to forgetting to turn off power supply.

To achieve this and other objects of the present invention, a wireless keyboard comprises a keyboard body carrying a set of operating key switches on a top side thereof, an elongated spacer block, hinge means, for example, a narrow elongated hinge strip formed integral with and connected between the front side of the keyboard body and the elongated spacer block for allowing the elongated spacer block to be turned between a first position where the elongated spacer block is kept at the front side of the keyboard body in a substantially flush manner and a second position where the elongated spacer block is attached to a bottom side of the keyboard body for supporting the keyboard body on a flat surface in a tilted condition, a magnetic member embedded in the elongated spacer block, and a circuit module mounted inside the keyboard body between the set of operating key switches and the elongated spacer block. The circuit module comprises a circuit board electrically coupled with the operating key switches, a battery power supply electrically connected to the circuit board for providing the circuit module with the necessary working power, a wireless module electrically connected to the circuit board, and a solenoid switch electrically connected to the circuit board and disposed corresponding to and electrically switchable by the magnetic member to turn off the battery power supply when the elongated spacer block is turned away from the second position to the first position and to turn on the battery power supply when the elongated spacer block is turned from the first position to the second position.

Further, at least one, for example, two torsion springs are bilaterally set between the keyboard body and the elongated spacer block for normally supporting the elongated spacer block in the first position. In the case that the elongated spacer block is made of a non-hard material, the torsion springs normally support the elongated spacer block in the first position (power-off position) and in shape, and the elongated spacer block will not fall or curve down due to the effect of its gravity weight.

### BRIEF DESCRIPTION OF THE DRAWINGS

FIG. 1 is a perspective view of a wireless keyboard in accordance with a first embodiment of the present invention.

FIG. 2 is a schematic side view, in an enlarged scale, of a part of FIG. 1, illustrating the elongated spacer block kept in the first position.

FIG. 3 corresponds to FIG. 1, illustrating the elongated spacer block turned to the second position and attached to the bottom side of the keyboard body.

FIG. 4 is a schematic side view, in an enlarged scale, of a part of FIG. 3, illustrating the elongated spacer block kept in the second position.

FIG. 5 is a perspective view of a wireless keyboard in accordance with a second embodiment of the present invention.

### DETAILED DESCRIPTION OF THE PREFERRED EMBODIMENT

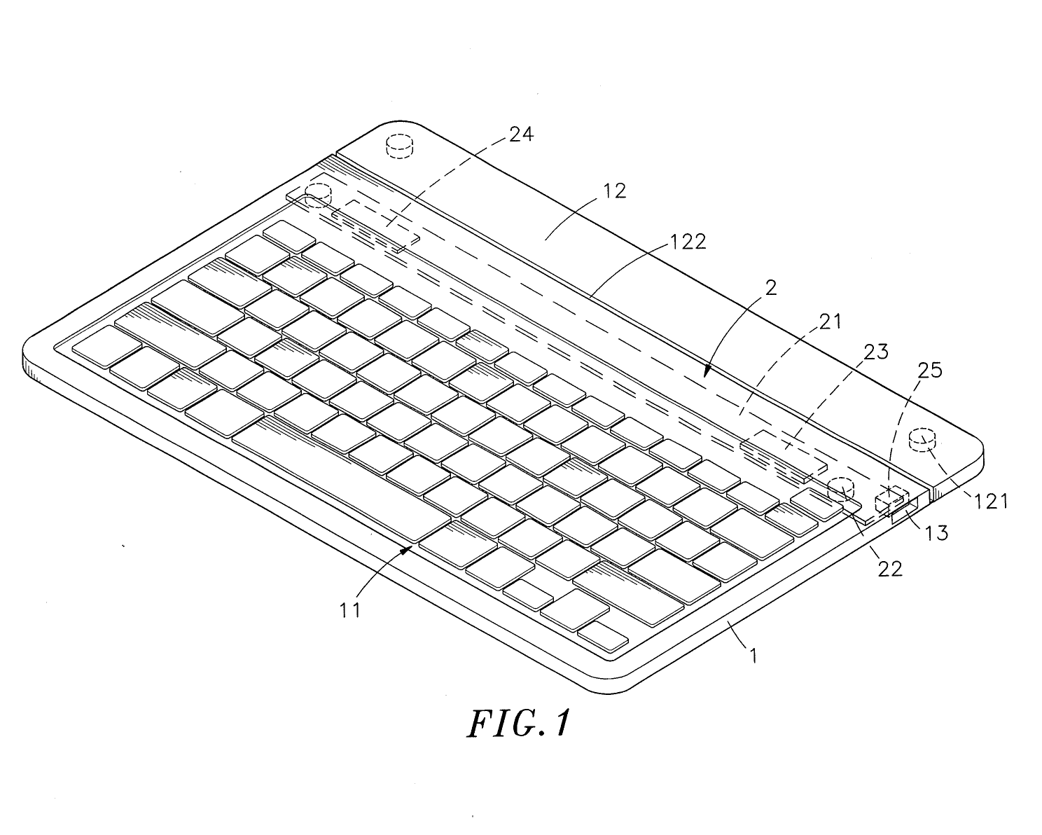

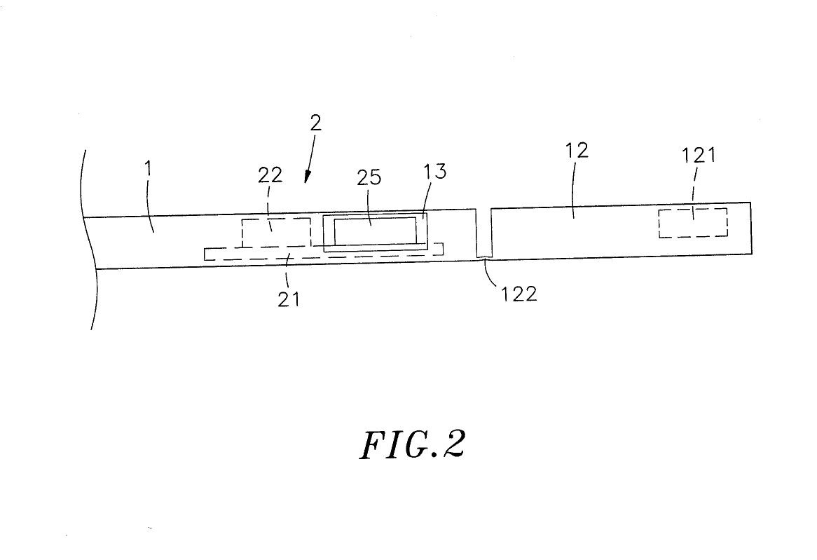

Referring to FIGS. 1 and 2, a wireless keyboard with a specially designed power switch structure in accordance with a first embodiment of the present invention is shown.

The wireless keyboard comprises a keyboard body 1, which carries a set of operating key switches 11 on the top side thereof and has at least one side hole 13 located on the peripheral wall thereof, an elongated spacer block 12, a narrow elongated hinge strip 122 formed integral with and connected between the front side of the keyboard body 1 and the elongated spacer block 12 for allowing the elongated spacer block 12 to be turned between a first position where the elongated spacer block 12 is kept at the front side of the keyboard body 1 in a substantially flush manner and a second position where the elongated spacer block 12 is attached to the bottom side of the keyboard body 1, at least one, for example, two magnetic members 121 embedded in the elongated spacer block 12 near opposing left and right ends of the elongated spacer block 12, and a circuit module 2 mounted inside the keyboard body 1 between the set of operating key switches 11 and the elongated spacer block 12. The circuit module 2 comprises a circuit board 21 electrically coupled with the operating key switches 11, at least one, for example, two solenoid switches 22 electrically connected to the circuit board 21 and respectively disposed corresponding to the magnetic members 121, a wireless module 23 electrically connected to the circuit board 21, and a battery power supply 24 electrically connected to the circuit board 21 for providing the circuit module 2 with the necessary working power.

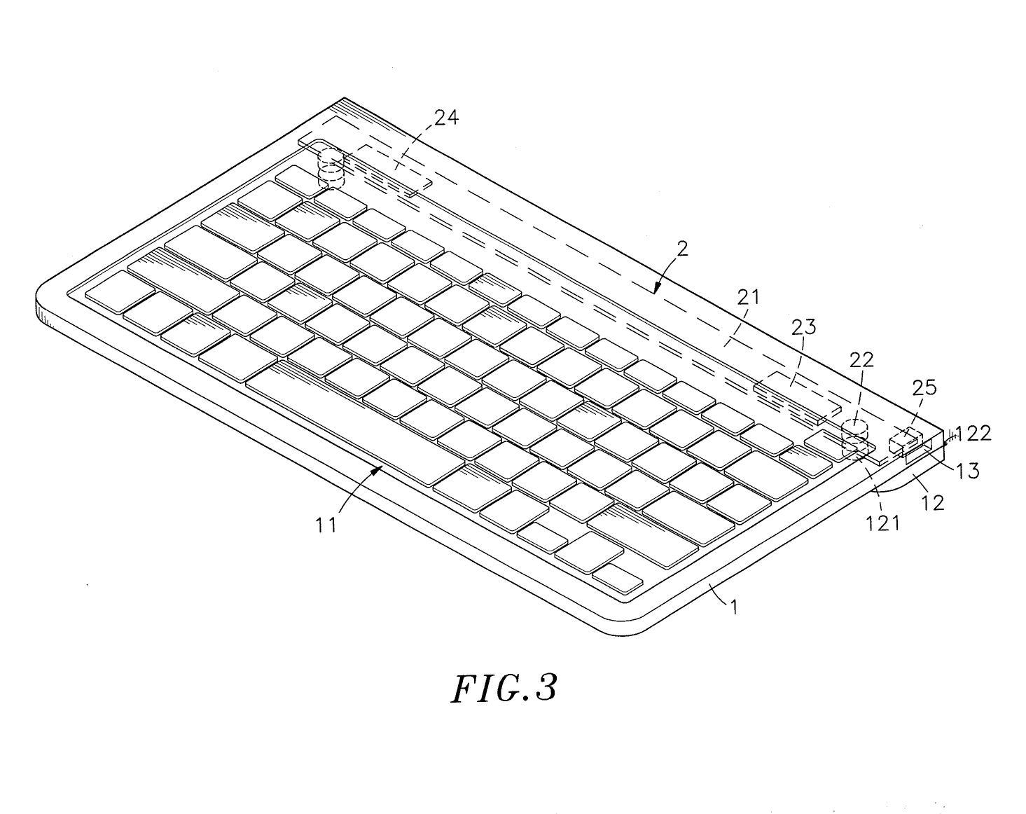

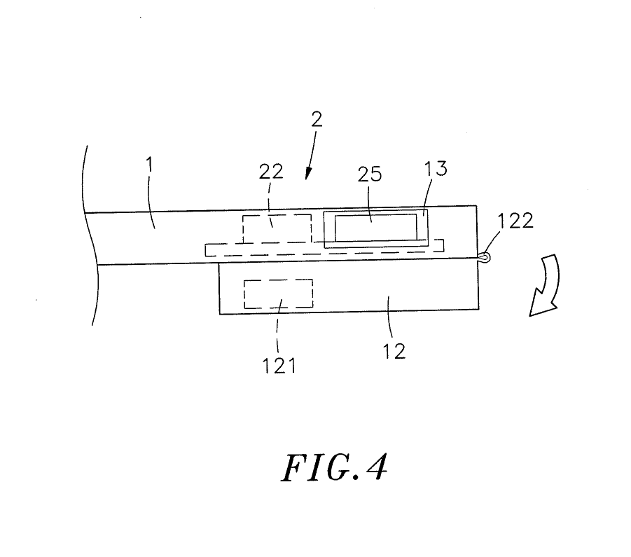

Referring to FIGS. 3 and 4 and FIGS. 1 and 2 again, when the wireless keyboard is not in use, the elongated spacer block 12 is turned to the first position and kept on the front side of the keyboard body 1 in a substantially flush manner, When wishing to use the wireless keyboard, turn the elongated spacer block 12 to the second position and the elongated spacer block 12 is kept attached to the bottom side of the keyboard body 1. At this time, the elongated spacer block 12 supports the keyboard body 1 on a flat surface in a tilted position, facilitating access to the operating key switches 11. Further, when the elongated spacer block 12 is turned to the second position and kept attached to the bottom side of the keyboard body 1, the magnetic members 121 in the elongated spacer block 12 are respectively aimed at the solenoid switches 22, actuating the solenoid switches 22 to switch on the power circuit of the battery power supply 24 of the circuit module 2, enabling the battery power supply 24 to provides battery power to the operating key switches 11 of the keyboard body 1 and the circuit board 21 and wireless module 23 of the circuit module 2. Thus, the wireless keyboard can be linked to an electronic master device (such as, tablet PC, desk computer, smart phone, etc.), allowing the user to operate the electronic master device wirelessly.

Further, each key switch 11 of the keyboard body 1 comprises a key cap, a circuit board, a rubber cone, a light shield, a light-emitting component and/or a scissor link, and operable to provide a respective switching signal to the circuit module 2. As the design of the key switches 11 is of the known art, no further detailed description in this regard will be necessary.

After the use of the wireless keyboard, the elongated spacer block 12 is turned back from the second position to the first position and kept at the front side of the keyboard body 1 in a substantially flush manner to reduce the keyboard thickness convenient for receiving in a covering or bag. At this time, the magnetic members 121 in the elongated spacer block 12 are kept far away from the solenoid switches 22 of the circuit module 2, causing the solenoid switches 22 to switch off the power circuit of the battery power supply 24 of the circuit module 2. Thus, as no further switching action to switch off the power circuit of the battery power supply 24 of the circuit module 2 is necessary, no power loss due to forgetting to turn off power supply.

Further, any other hinge design or pivot structure may be used to substitute for the narrow elongated hinge strip 122, allowing the elongated spacer block 12 to be turned relative to the keyboard body 1 between the first position (power-off position) and the second position (power-on position). Further, the wireless module 23 can be configured subject to one of Wi-Fi, Zigbee and RF communication protocols.

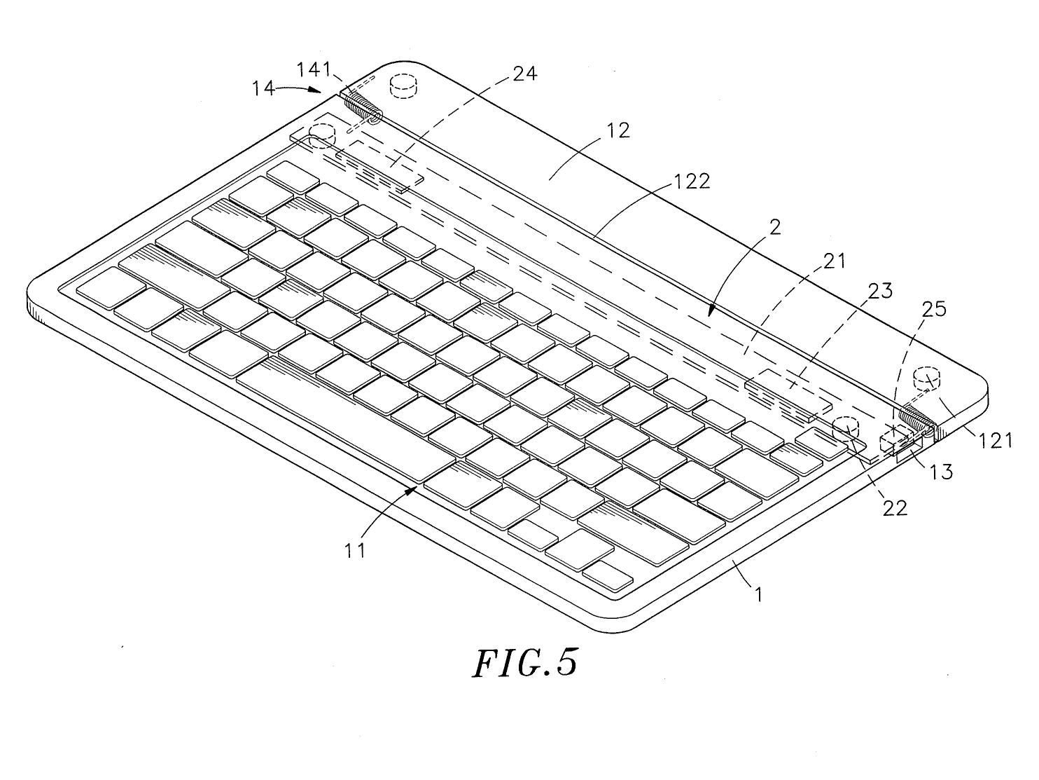

Referring to FIG. 5, a wireless keyboard with a specially designed power switch structure in accordance with a second embodiment of the present invention is shown. This second embodiment is substantially similar to the aforesaid first embodiment with the exception that this second embodiment further comprises two torsion springs 14 bilaterally arranged between the keyboard body 1 and elongated spacer block 12, each having two opposing legs 141 respectively stopped against the keyboard body 1 and elongated spacer block 12 to support the elongated spacer block 12 in the first position. When turning the elongated spacer block 12 from the first position to the second position, the torsion springs 14 are compressed. When released the pressure from the elongated spacer block 12, the torsion springs 14 immediately return to their former shape, biasing the elongated spacer block 12 from the second position to the first position. Further, one relatively longer single torsion spring can be used to substitute for the aforesaid two torsion springs 14. When one single torsion spring is used, the torsion spring must be arranged on the middle with the two opposing legs respectively stopped against the keyboard body 1 and elongated spacer block 12.

The arrangement of the torsion spring(s) 14 supports the elongated spacer block 12 normally in the first position. Further, the keyboard body 1 and the elongated spacer block 12 can be made of a hard material, such as metal, wood or hard plastics, or a non-hard material, such as leather, fabric, rubber or silicon rubber. If the keyboard body 1 and the elongated spacer block 12 are made of a non-hard material, the elongated spacer block 12 will not fall or curve down due to the effect of its gravity weight, and can be returned to the first position by the torsion spring(s) 14 easily and automatically after the use of the wireless keyboard. When the user picks up the wireless keyboard from the top surface of a table, desk or support, the elongated spacer block 12 will be automatically returned to the first position (power-off position), achieving enhanced convenience in use, avoiding power loss and maintaining the sense of beauty.

Referring to FIG. 1 and FIG. 5 again, the circuit module 2 further comprises at least one electrical connector 25 (for example, USB connector, power connector, or audio connector) electrically connected to the circuit board 21 and respectively facing toward the at least one side hole 13 for the connection of a mating electrical connector of an external battery charger or audio player. Further, a solar panel may be mounted on the outside of the keyboard body 1 for converting sunlight into electricity for charging the battery power supply 24.

In conclusion, the invention provides a wireless keyboard with a specially designed power switch structure, which has the advantages and features as follows:

1. The elongated spacer block 12 can be turned relative to the keyboard body 1 from the first position in flush with the keyboard body 1 to the second position at the bottom side of the keyboard body 1 to actuate the at least one solenoid switch 22 of the circuit module 2 in switching on the power circuit of the battery power supply 24 and to support the keyboard body 1 on a flat surface in a tilted position, facilitating access to the operating key switches 11. When turning back the elongated spacer block 12, the thickness of the wireless keyboard is minimized and the power circuit of the battery power supply 24 is switched off, avoiding the problem of power loss due to forgetting to turn off power supply.

2. Torsion springs 14 can be coupled between the keyboard body 1 and the elongated spacer block 12 to normally support the elongated spacer block 12 in the first position (power-off position). When the wireless keyboard is lifted from the supporting surface after the use, the elongated spacer block 12 is automatically returned by the torsion springs 14 from the second position (power-on position) to the first position (power-off position), avoiding the problem of power loss due to forgetting to turn off power supply and enhancing the convenience in use.

3. In the case that the elongated spacer block 12 is made of a non-hard material, the torsion springs 14 normally support the elongated spacer block 12 in the first position (power-off position) and keep it in shape, and the elongated spacer block 12 will not fall or curve down due to the effect of its gravity weight.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A wireless keyboard, comprising:
a keyboard body carrying a set of operating key switches on a top side thereof;
an elongated spacer block;
hinge means connected between said keyboard body and said elongated spacer block for allowing said elongated spacer block to be turned between a first position where said elongated spacer block is kept at the front side of said keyboard body in a substantially flush manner and a second position where said elongated spacer block is attached to a bottom side of said keyboard body for supporting said keyboard body on a flat surface in a tilted condition;
at least one magnetic member embedded in said elongated spacer block; and
a circuit module mounted inside said keyboard body between said set of operating key switches and said elongated spacer block, said circuit module comprising a circuit board electrically coupled with said operating key switches of said set of operating key switches, a battery power supply electrically connected to said circuit board for providing said circuit module with the necessary working power, a wireless module electrically connected to said circuit board, and at least one solenoid switch electrically connected to said circuit board and respectively disposed corresponding to and electrically switchable by said at least one magnetic member to turn off said battery power supply when said elongated spacer block is turned away from said second position to said first position and to turn on said battery power supply when said elongated spacer block is turned from said first position to said second position.

2. The wireless keyboard as claimed in claim 1, wherein said hinge means is a narrow elongated hinge strip formed integral with and connected between a front side of said keyboard body and said elongated spacer block.

3. The wireless keyboard as claimed in claim 1, wherein said hinge means is a pivot hinge.

4. The wireless keyboard as claimed in claim 1, wherein said wireless module is configured subject one of Wi-Fi, Zigbee and RF communication protocols.

5. The wireless keyboard as claimed in claim 1, further comprising at least one torsion spring set between said keyboard body and said elongated spacer block and adapted for normally supporting said elongated spacer block in said first position, each said torsion spring comprising two opposite legs respectively stopped against said keyboard body and said elongated spacer block.

6. The wireless keyboard as claimed in claim 1, wherein said keyboard body further comprises at least one side hole located on the periphery thereof; said circuit module further comprises at least one electrical connector electrically connected to said circuit board and respectively facing toward said at least one side hole of said keyboard body for the connection of a mating electrical connector of an external electronic device.

7. The wireless keyboard as claimed in claim 6, wherein said electrical connector is a USB connector.

8. The wireless keyboard as claimed in claim 6, wherein said electrical connector is a power connector.

9. The wireless keyboard as claimed in claim 6, wherein said electrical connector is an audio connector.
